(19) United States
(12) Patent Application Publication
(10) Pub. No.: US 2006/0184991 A1
(43) Pub. Date: Aug. 17, 2006

(54) System and method of providing television content

(75) Inventors: Michael Schlamp, Austin, TX (US); Larry L. Crabb, Austin, TX (US)

Correspondence Address: LARSON NEWMAN ABEL POLANSKY & WHITE, LLPL., 5914 WEST COURTYARD DRIVE, SUITE 200, AUSTIN, TX, 78746, US

(73) Assignee: SBC Knowledge Ventures, LP

(21) Appl. No.: 11/057,858

(22) Filed: Feb. 14, 2005

(51) Int. Cl. H04N 7/173

(52) U.S. Cl. 725/120; 725/100; 725/131

(57) ABSTRACT

A method of providing television content includes receiving a channel selection at a television and determining whether the selected channel is provided within a user-defined multi-channel analog stream from a set top box. The multi-channel analog stream can include one hundred and twenty five user selected channels. Further, the user-defined multi-channel analog stream is created from a digital satellite signal. The television can be tuned to the channel after determining that the channel is provided within the user-defined multi-channel analog stream. The method includes determining whether the television is serviced by the set top box. A satellite signal is decoded for the channel at the set top box after determining that the channel is not provided within the user-defined multi-channel analog stream and after determining that the television is serviced by the set top box. A single channel signal associated with the channel can be transmitted to the television.

### FIELD OF THE DISCLOSURE

The present disclosure relates to portable computing device.

### BACKGROUND

Satellite television service has become extremely popular as an alternative to cable television service. A typical satellite television system includes a satellite dish that is deployed at a customer location and that is coupled to a user television via a set top box. The set top box can decode a satellite television signal and transmit a decoded signal to the set top box. In order for each television at a customer location to receive content from the satellite signal, a set top box is coupled to each television. However, most satellite systems are limited in that they can only sustain three additional set top boxes without signal degradation and loss of service.

In order to provide content to the additional televisions without requiring additional set top boxes, some satellite systems provide a one hundred and twenty five (125) channel analog signal that is mixed with the digital signal. The digital signal can be decoded by the set top box and a single channel signal can be transmitted to a television coupled to the set top box. Further, the 125 channel analog signal can be transmitted throughout the household cable distribution system without passing through the set top box. This method allows a customer with multiple televisions to designate one television to receive digital content from the set top box. The remaining televisions can receive the standard 125 channel analog signal and can be tuned to the channels included therein. Unfortunately, the channels provided by the 125 channel analog signal are selected by the content provider and every customer receives the same 125 analog channels.

Accordingly, there is a need for an improved system and method of providing television content.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram representative of a television system;

FIG. 2 is a flow chart to illustrate a method of configuring a set top box to provide television content; and

FIG. 3 is a flow chart to illustrate a method of providing television content.

### DETAILED DESCRIPTION OF THE DRAWINGS

A method of providing television content includes receiving a channel selection at a television and determining whether a channel identified by the channel selection is provided within a user-defined multi-channel analog stream from a set top box. In a particular embodiment, the multi-channel analog stream can include one hundred and twenty five user selected channels. Further, the user-defined multi-channel analog stream is created from a digital satellite signal. In a particular embodiment, the television can be tuned to the channel after determining that the channel is provided within the user-defined multi-channel analog stream.

In a particular embodiment, the method includes determining whether the television is serviced by the set top box. A satellite signal is decoded for the channel at the set top box after determining that the channel is not provided within the user-defined multi-channel analog stream and after determining that the television is serviced by the set top box. Then, a single channel signal associated with the channel can be transmitted to the television for the channel.

Further, in a particular embodiment, the method includes indicating that the channel is unavailable after determining that the channel is not provided within the user-defined multi-channel analog stream and after determining that the television is not serviced by the set top box.

In another embodiment, a method of providing digital content and analog television content from a set top box is provided. The method includes receiving a satellite signal and converting a group of selected channels within the satellite signal into a multi-channel analog stream based on a group of channels selected by a user.

In yet another embodiment, a video system is provided and includes a first television and a second television. A set top box is coupled to the first television and the second television. The set top box can transmit a single channel signal and a user-defined multi-channel analog stream to the first television. Further, the set top box transmits the user-defined multi-channel analog stream to the second television.

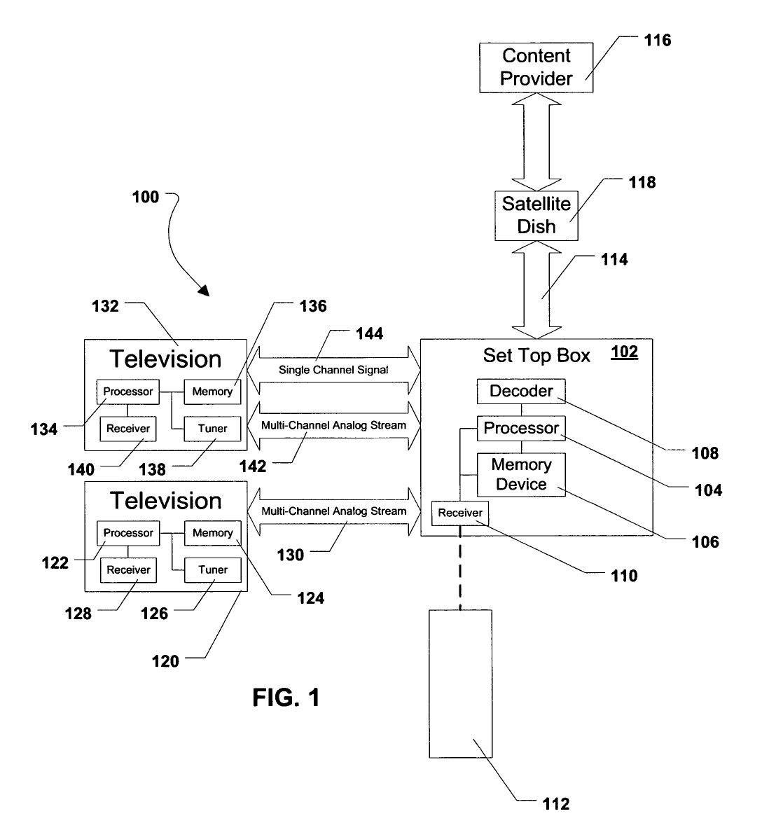

Referring to FIG. 1, a video system is shown and is generally designated 100. As shown, the television system 100 includes a set top box 102. In an illustrative embodiment, the set top box 102 includes a processor 104 and a memory device 106 that is coupled to the processor 104. Further, a digital signal decoder 108 is coupled to the processor 104 and a receiver 110 can also be coupled to the processor 104. In a particular embodiment, the receiver 110 is an (IR) infrared receiver or a radio frequency (RF) receiver and can receive one or more control signals from a remote control device 112 that can be used to control the set top box 102. As illustrated in FIG. 1, the set top box 102 receives a satellite signal 114 from a content provider 116. In a particular embodiment, the satellite signal 114 can be received via a satellite dish 118 that is coupled to the set top box 102.

FIG. 1 further shows that a first television 120 can be coupled to the set top box 102. The first television 120 includes a processor 122. A memory 124 and a tuner 126 can be coupled to the processor 122. Further, a receiver 128, e.g., an IR receiver or an RF receiver, can be coupled to the processor 122. In a particular embodiment, the receiver 128 can receive one or more control signals from the remote control device 112. Further, in a particular embodiment, the first television 120 can receives a multi-channel analog stream 130 from the set top box 102. During operation, the tuner 126 within the first television 120 can be tuned to receive any of the channels provided by the multi-channel analog stream 130. In a particular embodiment, the multi-channel analog stream 130 includes one hundred and twenty five (125) channels that can be selected by a user during configuration.

As illustrated in FIG. 1, a second television 132 can also be coupled to the set top box 102. As depicted in FIG. 1, the second television 132 includes a processor 134. A memory 136 and a tuner 138 can be coupled to the processor 134. Further, the second television 132 can include a receiver 140 that can receive one or more controls from the remote control device 112. FIG. 1 further shows that the set top box 102 transmits a multi-channel analog stream 142 to the second television 132. In a particular embodiment, the tuner 138 within the second television 132 can tune to each channel provided by the multi-channel analog stream 142.

Additionally, the set top box 102 can transmit a single channel signal 144 to the second television 132. In a particular embodiment, the single channel signal 144 represents a channel that is not included within the multi-channel analog stream. Further, the single channel signal 144 represents a channel that is selected at the set top box 102, decoded from the satellite signal 114 at the set top box 102, and transmitted to the second television 132. Moreover, the single channel signal 144 can be provided to a television, such as the second television 128, that is directly serviced by the set top box 102.

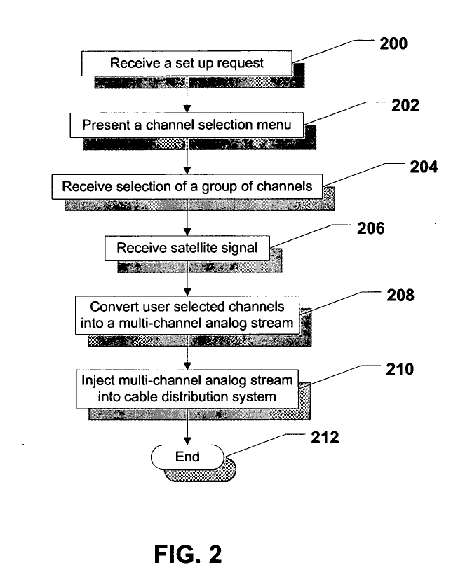

Referring to FIG. 2, a method of configuring a set top box to provide television content is shown and commences at block 200. At block 200, the set top box receives a set up request from a user. At block 202, the set top box presents a channel selection menu to the user via a television. In a particular embodiment, the channel selection menu can include a menu of every channel that is available to a television via a set top box. Next, at block 204, the set top box receives a selection of a group of channels that the user wants to have included in a multi-channel analog stream that will be transmitted to the television and that can be tuned by the television but not the set top box. In a particular embodiment, the user can select the channels to be grouped in the multi-channel analog stream based on his or her viewing preferences or based on one or more parental controls. Further, the user can select the channels by highlighting them in a list provided in the channel selection menu.

Moving to block 206, the set top box receives a satellite signal. At block 208, the set top box converts the user selected channels into a multi-channel analog stream that can be tuned at the television, but not at the set top box. Proceeding to block 210, the set top box injects the multi-channel analog stream into a cable distribution system at the user location. Each television that is coupled to the cable distribution system can receive the multi-channel analog stream. Further, each television that receives the multi-channel analog stream can be independently tuned to each channel provided by the multi-channel analog stream. The method then ends at state 212.

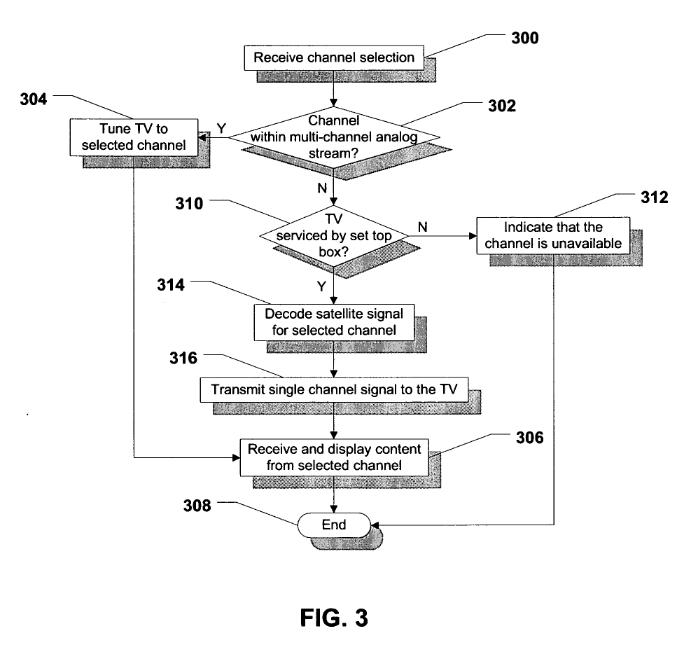

Referring to FIG. 3, a method of providing television content is shown and begins at block 300. At block 300, a television receives a channel selection. In a particular embodiment, the channel selection can be made using a remote control device. At decision step 302, the television determines whether the selected channel is part of the group of channels provided by a multi-channel analog stream received from a set top box. If so, the method continues to block 304 and the television is tuned to the selected channel. Then, at block 306, the television receives and displays television content from the selected channel. The method then ends at state 308.

Returning to decision step 302, if the selected channel is not included in the group of channels provided by the multi-channel analog stream, the method moves to decision step 310. At decision step 310, the television determines whether it is serviced by the set top box. In other words, the television determines whether or not it receives single channel signals from the set top box for channels not within the multi-channel analog stream. If the television is not serviced by the set top box, the method proceeds to block 312, and the television indicates that the channel is unavailable. The method then ends at state 308.

If the television is serviced by the set top box, the method moves to block 314 and the set top box decodes the satellite signal for the selected channel. At block 316, the single channel signal is transmitted from the set top box to the television. In a particular embodiment, the single channel signal can be an analog signal, an S-video signal, or an RGB signal. Then, at block 306, the television receives and displays content from the selected channel. The method ends at state 308.

With the configuration of structure described above, the system and method of providing television content provides a way for a user to receive digital content at a single television and receive a multi-channel analog stream that includes user selected channels at other televisions. Further, the present system and method allows a customer the ability to source multiple televisions without having to purchase or rent multiple set top box boxes. Additionally, the method allows the customer the flexibility in choosing which television channels are converted into the multi-channel analog signal. As such, a user is not limited to a static, pre-defined analog stream from a content provider.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing television content, the method comprising:
receiving a channel selection at a television; and
determining whether a channel identified by the channel selection is provided within a user-defined multi-channel analog stream from a set top box.

2. The method of claim 1, further comprising tuning the television to the channel after determining that the channel is provided within the user-defined multi-channel analog stream.

3. The method of claim 2, further comprising determining whether the television is serviced by the set top box.

4. The method of claim 3, further comprising decoding a satellite signal for the channel at the set top box after determining that the channel is not provided within the user-defined multi-channel analog stream and after determining that the television is serviced by the set top box.

5. The method of claim 4, further comprising transmitting a single channel signal associated with the channel to the television for the channel.

6. The method of claim 3 further comprising indicating that the channel is unavailable after determining that the channel is not provided within the user-defined multi-channel analog stream and after determining that the television is not serviced by the set top box.

7. The method of claim 1, wherein the multi-channel analog stream includes one hundred and twenty five user selected channels.

8. The method of claim 7, wherein the user-defined multi-channel analog stream is created from a digital satellite signal.

9. A method of providing digital content and analog television content from a set top box, the method comprising:
receiving a satellite signal; and
converting a group of selected channels within the satellite signal into a multi-channel analog stream based on a group of channels selected by a user.

10. The method of claim 9, further comprising transmitting a user-defined multi-channel analog stream to one or more televisions connected to the set top box.

11. The method of claim 10, further comprising receiving a channel selection at a television.

12. The method of claim 11, further comprising tuning the television to a selected channel when the selected channel is within the user-defined multi-channel analog stream.

13. The method of claim 11, further comprising decoding the satellite signal for the selected channel after determining that the selected channel is not within the user-defined multi-channel analog stream to yield a single channel signal.

14. The method of claim 12, further comprising transmitting the single channel signal to a television that is configured to receive content from the set top box.

15. The method of claim 11, further comprising indicating that a selected channel is unavailable when the selected channel is not within the user-defined multi-channel analog stream and when the television is not configured to receive all content from the set top box.

16. A video system, comprising:
a first television;
a second television;
a set top box coupled to the first television and the second television, wherein the set top box transmits a single channel signal and a user-defined multi-channel analog stream to the first television and wherein the set top box transmits the user-defined multi-channel analog stream to the second television.

17. The video system of claim 16, further comprising a processor, a memory accessible to the processor, and a computer program embedded within the memory, the computer program including instructions to present a channel selection menu to a user.

18. The video system of claim 17, wherein the computer program further comprises instructions to receive a selected group of channels from a user.

19. The video system of claim 18, wherein the computer program further comprises instructions to convert the selected group of channels within a digital channel signal to the user-defined multi-channel analog stream.

20. The video system of claim 19, wherein the computer program further comprises instructions to inject the user-defined multi-channel analog stream into a cable distribution system at a user location.
